(19) United States
(12) Patent Application Publication
(10) Pub. No.: US 2014/0220275 A1
(43) Pub. Date: Aug. 7, 2014

(54) SURFACE TREATMENT METHOD FOR PLASTIC SUBSTRATE AND HOUSING USING THE SUBSTRATE

(71) Applicants: FIH (HONG KONG) LIMITED, Kowloon (HK); SHENZHEN FUTAIHONG PRECISION INDUSTRY CO., LTD., Shenzhen (CN)

(72) Inventor: XU LIU, Shenzhen (CN)

(21) Appl. No.: 13/935,891

(22) Filed: Jul. 5, 2013

(30) Foreign Application Priority Data
Feb. 4, 2013 (CN) 2013100426014

(51) Int. Cl. B32B 1/02; B32B 37/02

(52) U.S. Cl. CPC B32B 1/02; B32B 37/02
USPC 428/35.9; 156/242; 428/35.7

(57) ABSTRACT

A surface treatment method for plastic substrate provides an illusion of a three-dimensional weave surface with a high gloss finish. A first shielding sheet with a shielding area, and a plurality of parallel rows of first holes is provided. The first shielding sheet is pasted on a film, and then a first pattern layer is printed on the film, the first pattern layer being translucent. A background layer is formed on the first pattern layer, the color of the background layer being different from the color of the first pattern layer; and the plastic substrate is combined with the film by insert molding, the first pattern layer and the background layer being located between the film and the plastic substrate. A housing manufactured by the method is also provided.

### BACKGROUND

1. Technical Field

The exemplary disclosure generally relates to surface treatment method for plastic substrate and housing using the plastic substrate.

2. Description of Related Art

Electronic products having weave-surface appearance are very popular. The weave can be formed by wire-drawing, hot pressing metal net, and CNC numerical control machine engraving. However, wire-drawing cannot make the weave to appear three-dimensional. Metal net cannot firmly attach to the housing and the weave formed by CNC appear disorderly.

Therefore, there is room for improvement within the art.

### BRIEF DESCRIPTION OF THE FIGURES

Many aspects of the housing can be better understood with reference to the following figures. The components in the figures are not necessarily drawn to scale, the emphasis instead being placed upon clearly illustrating the principles of the housing. Moreover, in the drawings, like reference numerals designate corresponding parts throughout the several views.

FIG. 1 is a cross-sectional view of an exemplary embodiment of a housing having a weave appearance.

FIG. 2 is a schematic view of an exemplary embodiment of a first shielding sheet.

FIG. 3 is a schematic view of the housing of FIG. 1.

FIG. 4 is a schematic view of an exemplary embodiment of a second shielding sheet.

### DETAILED DESCRIPTION

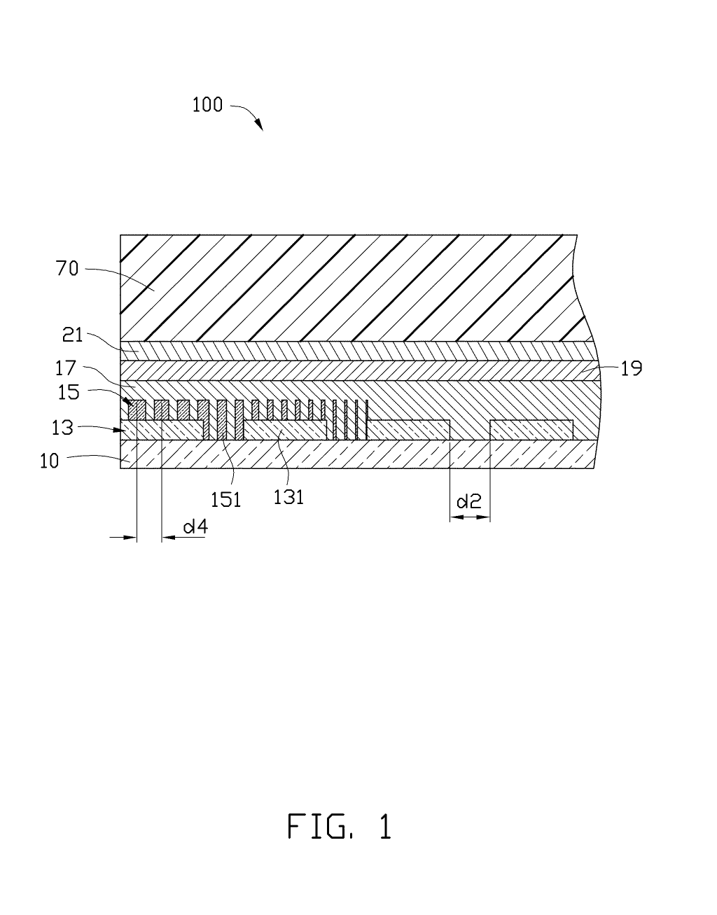

Referring to FIG. 1, an exemplary surface treatment method for plastic substrate may include at least the following steps:

(1) A film 10 is provided.

The film 10 is transparent or translucent. The thickness of the film 10 is about 0.075 cm to about 0.175 cm. In the exemplary embodiment, the film 10 is made of polyethylene terephthalate.

(2) A first pattern layer 13 is formed on the film 10.

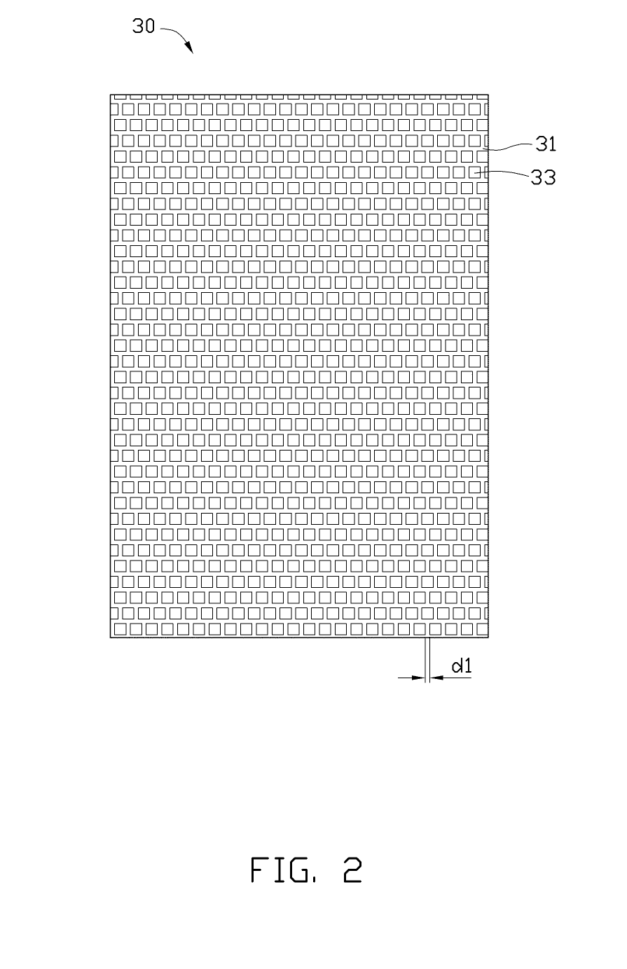

Referring to FIG. 2, a first shielding sheet 30 is provided. The first shielding sheet 30 has a shielding area 31 and a plurality first holes 33 arranged in parallel rows. Each two adjacent rows of the first holes 33 are staggered from each other. In the exemplary embodiment, a distance d1 between two adjacent first holes 33 in each row is about 0.75 mm. In the exemplary embodiment, the first hole 33 has a rectangular shape.

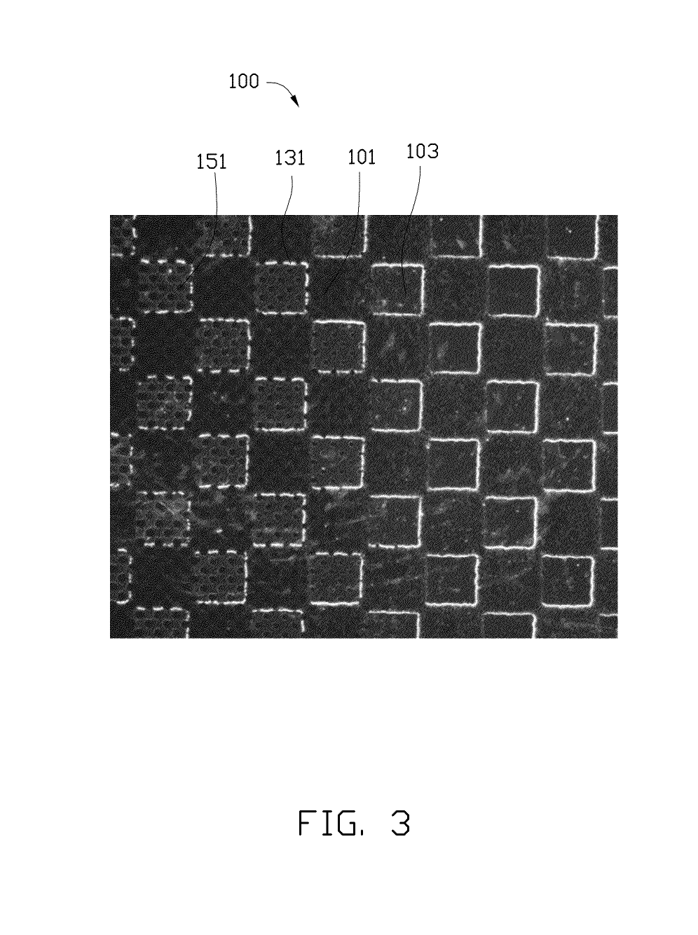

Referring to FIG. 3, the first shielding sheet 30 is pasted on the film 10 to cover portions of the film 10 corresponding to the shielding area 31, and then a pattern layer 13 is formed on the film 10 by printing. The first pattern layer 13 has a plurality of first decorative areas 131 arranged in rows corresponding to the first holes 33. Each two adjacent rows of the first decorative areas 131 are staggered from each other. The thickness of the first pattern layer 13 is about 5 μm to about 8 μm. In the exemplary embodiment, a distance d2 between two adjacent first decorative areas 131 in a row is about 0.75 mm (see FIG. 1).

The first pattern layer 13 may be made of ink containing polyurethane resin and aluminum powder. The first pattern layer 13 is silvery white and translucent. The aluminum powder provides an aluminum metal appearance to the first pattern layer 13.

(3) A second pattern layer 15 is formed on the first pattern layer 13.

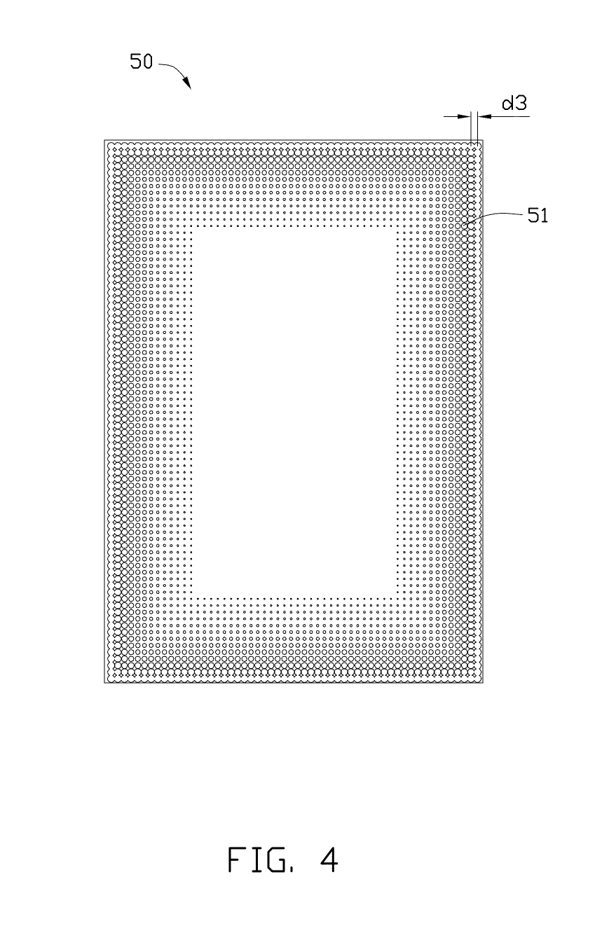

Referring to FIG. 4, a second shielding sheet 50 is provided. The second shielding sheet 50 defines a plurality of second holes 50 adjacent to the edges thereof. The diameter of each second hole 50 is about 0.1 mm to about 0.55 mm. The diameters of the second holes 50 gradually decrease from the edges of the shielding sheet 50 to the center of the shielding sheet 50. A distance d3 between the centers of each two adjacent second holes 51 is about 0.25 mm to about 1 mm. The second hole 50 has a circular shape.

The second shielding sheet 50 is pasted on the first shielding sheet 30 to cover portions of the first pattern layer 13 and/or the film 10, and then a second pattern layer 15 is formed on the first pattern layer 13 by printing. The second pattern layer 15 has a plurality of second decorative areas 151 arranged at spaced intervals corresponding to the second holes 50. The second decorative area 151 has a circular shape.

The diameter of the second decorative area 151 is about 0.1 mm to about 0.55 mm. The diameters of the second decorative areas 151 gradually decrease from the edges of the second pattern layer 15 to the center of the second pattern layer 15. The distance d4 between the centers of each two adjacent decorative areas 151 is about 0.25 mm to about 1 mm. The second pattern layer 15 has a thickness of about 5 μm to about 8 μm. The second pattern layer 15 is brown and translucent.

(4) A background layer 17 is formed on the second pattern layer 15 by printing.

The background layer 17 has a thickness of about 5 μm to about 8 μm. The background layer 17 has a color different from the color of the first pattern layer 13 and the second pattern layer 15. In the exemplary embodiment, the background layer 17 is black.

A protecting layer 19 is formed on the background layer 17 by printing.

The protecting layer 19 has a thickness of about 10 μm to about 12 μm. In the exemplary embodiment, the first pattern layer 13, the second pattern layer 15, the background layer 17, and the protecting layer 19 comprises ink containing polyurethane resin.

(6) A back adhesive layer 21 is formed on the protecting layer 19 by printing.

The back adhesive layer 21 includes acrylic acid, ethylene-vinyl acetate copolymer, or polypropylene. The back adhesive layer 21 has a thickness of about 10 μm to about 12 μm.

(7) A plastic substrate 70 is formed on the back adhesive layer 21 by insert molding.

In the exemplary embodiment, the plastic substrate 70 is made of polycarbonate resin.

Referring to FIG. 1, a housing 100 manufactured by the above method is also provided. The housing 100 includes a film 10 and a plastic substrate 70 combined with the film 10 by insert molding. The film 10 is transparent or translucent. The plastic substrate 70 is made of polycarbonate resin.

The housing 100 further includes a first pattern layer 13, a second pattern layer 15, a background layer 17, a protecting layer 19, and a back adhesive layer 21 formed between the film 10 and the plastic substrate 70.

The first pattern layer 13 is formed on the film 10. The first pattern layer 13 has a plurality of rows of first decorative areas 131. The first decorative areas 131 of adjacent two rows are staggered from each other. The thickness of the first pattern layer 13 is about 5 μm to about 8 μm. In the exemplary embodiment, the distance d2 between two adjacent first decorative areas 131 in a row is about 0.75 mm.

The first pattern layer 13 contains polyurethane resin and aluminum powder. The first pattern layer 13 is silvery white. The aluminum powder makes the first pattern layer 13 present an appearance like aluminum metal.

A second pattern layer 15 is formed on the first pattern layer 13. The second pattern layer 15 has a plurality of second decorative areas 151. The second decorative area 151 has a circular shape. The diameter of the decorative area 151 is about 0.1 mm to about 0.55 mm. The diameter of the decorative areas 151 gradually decreases from the edges of the second pattern layer 15 to the center of the second pattern layer 15. The distance d4 between the centers of each two adjacent decorative areas 151 is about 0.25 mm to about 1 mm. The second pattern layer 15 has a thickness of about 5 μm to about 8 μm. The second pattern layer 15 is brown and translucent.

The background layer 17 is formed on the second pattern layer 15, and is directly formed on either the first pattern layer 13 or the film 10. The background layer 17 has a thickness of about 5 μm to about 8 μm. The color of the background layer 17 is different from the colors of the first pattern layer 13 and the second pattern layer 15. In the exemplary embodiment, the background layer 17 is black.

The protecting layer 19 is formed on the background layer 17. The protecting layer 19 protects the background layer 17, the second pattern layer 15 and the first pattern layer 13 from damage by melted resin materials during insert molding process. The protecting layer 19 has a thickness of about 10 μm to about 12 μm.

The back adhesive layer 21 is formed on the protecting layer 19 and abuts the plastic substrate 70. The back adhesive layer 21 provides an enhanced bond between the film 10 and the plastic substrate 70. The back adhesive layer 21 contains acrylic acid, ethylene-vinyl acetate copolymer, or polypropylene. The back adhesive layer 21 has a thickness of about 10 μm to about 12 μm.

Alternatively, the protecting layer 19, and the back adhesive layer 21 can be omitted.

Referring to FIG. 3, the first decorative areas 131 overlap the background layer 17 to from a plurality of first rectangle patterns 101 having a metal and blue appearance. Portions of the background layer 17 indirectly formed on the film 10 form a plurality of second rectangle patterns 103 having a black appearance. The first rectangle patterns 101 and the second rectangle patterns 103 are staggered to provide a weave appearance. The weave appearance provides a strong illusion of a three-dimensional appearance. The weave appearance formed by the above method is precise, which gives the housing 100 a more attractive appearance. Additionally, the film 10 is smooth and has high reflectivity, which provides a high gloss weave appearance to the weave-surface housing 100.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A surface treatment method for plastic substrate comprising:
providing a film, the film being transparent or translucent;
providing a first shielding sheet, the first shielding sheet having a shielding area, and a plurality of first holes arranged in parallel rows, each two adjacent rows of the first holes being staggered from each other;
pasting the first shielding sheet on the film, and then printing a first pattern layer on the film, the first pattern layer being translucent;
forming a background layer on the first pattern layer, the color of the background layer being different from the color of the first pattern layer, the first decorative areas overlapping with the background layer to from a plurality of first rectangle patterns having weave appearance; and
insert molding a plastic substrate to combine with the film, the first pattern layer and the background layer being located between the film and the plastic substrate.

2. The method as claimed in claim 1, wherein the thickness of the first pattern layer is about 5 μm to about 8 μm.

3. The method as claimed in claim 1, wherein the distance between two adjacent first decorative areas in a row is about 0.75 mm.

4. The method as claimed in claim 1, wherein the first pattern layer comprises ink containing polyurethane resin and aluminum powder.

5. The method as claimed in claim 1, further comprising forming a second pattern layer on the first pattern layer by the following steps: providing a second shielding sheet, the second shielding sheet defines a plurality of second holes adjacent to the edges thereof, the diameters of the second holes gradually decreases from the edges of the shielding sheet to the center; pasting the second shielding sheet on the first shielding sheet, and then printing a second pattern layer on the first pattern layer.

6. The method as claimed in claim 5, wherein the diameter of each second hole is about 0.1 mm to about 0.55 mm.

7. The method as claimed in claim 5, wherein the distance between the centers of each two adjacent second holes is about 0.25 mm to about 1 mm.

8. The method as claimed in claim 5, wherein the second hole has a circular shape.

9. The method as claimed in claim 1, further comprising forming a protecting layer on the background layer.

10. The method as claimed in claim 9, further comprising forming a back adhesive layer on the protecting layer and abuts with the plastic substrate.

11. A housing, comprising:
a film being transparent or translucent;
a first pattern layer formed on the film, the first pattern layer having a plurality of first decorative area arranged in rows, each two adjacent rows of the first decorative area being staggered from each other, the first pattern layer being translucent,
a background layer formed on the first pattern layer, the color of the background layer being different from the color of the first pattern layer, the first decorative areas overlapping with the background layer to from a plurality of first rectangle patterns having weave appearance; and
a plastic substrate formed on the background layer.

12. The housing claimed in claim 11, wherein the thickness of the first pattern layer is about 5 μm to about 8 μm.

13. The housing claimed in claim 11, wherein the distance between two adjacent first decorative areas in a row is about 0.75 mm.

14. The housing claimed in claim 11, wherein the first pattern layer comprises aluminum powder.

15. The housing claimed in claim 11, further comprising a second pattern layer formed on the first pattern layer, the second pattern layer has a plurality of second decorative area arranged at spaced intervals, the diameters of the decorative areas gradually decreases from the edges of the second pattern layer to the center of the second pattern layer.

16. The housing claimed in claim 15, wherein the distance between the centers of each two adjacent decorative areas is about 0.25 mm to about 1 mm.

17. The housing claimed in claim 15, wherein the second pattern layer has a thickness of about 5 μm to about 8 μm.

18. The housing claimed in claim 15, wherein the second pattern layer is brown and translucent.

19. The housing claimed in claim 11, wherein the background layer has a thickness of about 5 μm to about 8 μm.

20. The housing claimed in claim 11, further comprising a protecting layer formed on the background layer.
